(19) United States
(12) Patent Application Publication
(10) Pub. No.: US 2008/0314602 A1
(43) Pub. Date: Dec. 25, 2008

(54) Portable fire extinguisher with manual and heat-responsive operators

(76) Inventor: Byron Lohnes, Fall River (CA)

Correspondence Address: MARIO D. THERIAULT, 812 HWY. 101 NASONWORTH, FREDERICTON, NB, E3C 2B5, CA

(21) Appl. No.: 11/812,688

(22) Filed: Jun. 21, 2007

(51) Int. Cl. A62C 3/00; A62C 13/78; A62C 13/76; A62C 37/00; A62C 35/02; A62C 13/00

(52) U.S. Cl. 169/56; 169/65; 169/19; 169/71

(57) ABSTRACT

The portable fire extinguisher has a housing, a pair of nozzles protruding from the housing, and a heat-responsive valve mounted outside the housing for detecting high heat intensity at proximity of the housing. The housing contains a cylinder of inert gas under pressure, a reservoir of fire suppressant material, and a piping system connecting the cylinder of inert gas, the heat-responsive valve, and the reservoir of fire suppressant material to the nozzles. The housing has a carrying handle formed thereon and magnets on surfaces thereof for retaining the housing to a range hood in a detachable manner. The piping system comprises a manual valve mounted in parallel with the heat-responsive valve for selective operation of the fire extinguisher in a manual mode. The heat-responsive valve is mounted near the top surface of the housing for detecting high heat intensity as close as possible from the ceiling of a range hood.

### FIELD OF THE INVENTION

This invention pertains to the field of portable fire extinguishers, and more particularly, it pertains to portable fire extinguishers that are selectively operable in a manual or in an automatic mode.

### BACKGROUND OF THE INVENTION

Fire prevention with cooking appliances has always been a major concern for parents and landlords. Safety practices are too often ignored in the faster pace of our modern life. Although many devices have been invented in the past for preventing kitchen fires, this field may never be safe enough to justify less vigilance.

The following documents provide a good inventory of fire extinguishers of the prior art that are mountable above a kitchen range to suppress a fire developing in a cooking pan.

U.S. Pat. No. 3,884,306 issued to Robert A. Williams on May 20, 1975;
U.S. Pat. No. 3,884,307 issued to Robert A. Williams on May 20, 1975;
U.S. Pat. No. 3,897,828 issued to John A. Glover on Aug. 5, 1975;
U.S. Pat. No. 5,518,075 issued to Robert A. Williams on May 21, 1996;
U.S. Pat. No. 6,029,751 issued to Wallace W. Ford et al., on Feb. 29, 2000;
U.S. Pat. No. 6,044,913 issued to Henry J. Stehling et al., on Apr. 4, 2000.
U.S. Pat. No. 6,276,461 issued to Daniel J. Stager on Aug. 21, 2001.

Although the fire extinguishers of the prior art are undoubtedly very efficient in suppressing a fire directly over a range-top burner, kitchen fires can occur in range ovens, in counter-top fryers, toaster ovens and electric pans. Kitchen fires also occur in garbage cans in which ashtrays have been inadvertently emptied for example.

The automatic fire extinguishers mentioned above are more or less fixedly mounted inside a range hood and therefore these devices are not usable for extinguishing a fire in an electric frying pan on a kitchen counter for example. Therefore, the provision of an automatic fire extinguisher under the range hood as those described in prior art literature, does not dispense someone from keeping a portable fire extinguisher at hand in a kitchen.

In another perspective, many people move to their cottages in the summer, or travel in recreational vehicles during their vacations. Students move into apartment during their school year. Although good fire prevention practices may be enforced in a principal residence, many neglect to apply the same rules when living away from home.

Therefore, there is a need in the field of fire prevention for a portable fire extinguisher that can be mounted under a range hood and operated automatically to prevent fire over a kitchen range, and that can be easily detached from its mounting an operated manually if needed. There is a need in this field of fire prevention for a fire extinguisher that can be taken from the home kitchen and mounted over the range in a recreational vehicle or in the kitchenette of a motel to increase fire prevention during outings.

### SUMMARY OF THE INVENTION

The portable fire extinguisher according to the present invention is mountable under a range hood in a readily detachable manner. It has a heat-responsive valve that is operable when intensive heat is present under the range hood, to spray a load of fire suppressant material over the range-top burners. A handle and a manual valve are also provided for operating the fire extinguisher in a manual mode if needed.

More specifically, the fire extinguisher comprises fire suppressant material under pressure in a container, a spray nozzle for delivering the fire suppressant material in a direction of a range-top burner, and a piping system connecting the container to the nozzle. The fire extinguisher is characterized by its manual valve and its heat-responsive valve mounted in parallel with each other, for selectively holding and releasing the fire suppressant material to the nozzle in a manual or automatic mode.

In use, the fire extinguisher is mounted under a range hood and is left there as a precautionary measure, for operation in an automatic mode. When the fire extinguisher is mounted under the range hood, it becomes very conspicuous to continually remind those using the kitchen range that it is readily available for use in a manual mode if ever the need arises.

In another aspect of the present invention, the fire extinguisher has a housing, at least one nozzle protruding from the housing, and a heat-responsive valve mounted outside the housing for detecting high heat intensity at proximity of the housing.

The housing contains a cylinder of inert gas under pressure, a reservoir of fire suppressant material, and a piping system connecting the cylinder to the heat-responsive valve, the heat-responsive valve to the reservoir of fire suppressant material and the reservoir of fire suppressant material to the nozzle. The housing has a carrying handle and magnets on a surface thereof for retaining the housing to a range hood in a detachable manner. The piping system has a manual valve mounted in parallel with the heat-responsive valve for selective operation of the fire extinguisher in a manual mode.

Because of its detachable mounting and its dual valves arrangement, the fire extinguisher is usable in different circumstances inside a home, such as above a fireplace, a clothe dryer, or a wood stove for example. Because of its handle, the fire extinguisher is easily transportable for use over a work bench, in a car, in a boat or when camping or cooking on an outdoor barbecue. The fire extinguisher is also movable from one apartment to another. This is convenient to students living in different apartments during their university degrees for example. A same fire extinguisher may be used throughout the entire period.

In another aspect of the present invention, there is provided a combination of a range hood having a ceiling and a zone of stagnant air at a proximity of the ceiling, and a fire extinguisher mounted inside the range hood. The fire extinguisher has at least one nozzle; a heat-responsive valve; a cylinder of inert gas under pressure, a reservoir of fire suppressant material, and a piping system connecting the cylinder to the heat-responsive valve; the heat-responsive valve to the reservoir of fire suppressant material, and the reservoir of fire suppressant material to the nozzle. The heat-responsive valve is mounted in the zone of stagnant air near the ceiling, for detecting intense heat at that location.

Should a fire occur in a cooking pan, heat rises and accumulates in a region of stagnant air surrounding the fan box of the hood. A sensing of heat intensity at that location provides an early detection of a fire in progress on a kitchen range. This aspect of the present invention is a major improvement over the range-hood fire extinguishers of the prior art having their heat sensors located below the fan box, where air currents tend to dissipate heat.

This brief summary has been provided so that the nature of the invention may be understood quickly. A more complete understanding of the invention can be obtained by reference to the following detailed description of an embodiment thereof in connection with the attached drawings.

### BRIEF DESCRIPTION OF THE DRAWINGS

One embodiment of a portable fire extinguisher is illustrated in the attached drawings. In these drawings the same numerals are used to identify the same elements. In the drawings;

FIG. 1 is a perspective front, top and left end view of the portable fire extinguisher according to one embodiment of the present invention;

FIG. 2 is a perspective rear, top and left end view of the fire extinguisher;

FIG. 3 is a longitudinal cross-section through the housing of the fire extinguisher, showing the elements of the fire extinguisher;

FIG. 4 is an elevation view, in a single-plane arrangement, of the piping system joining the elements of the fire extinguisher;

FIG. 5 front, right side and bottom perspective view of a range hood with the fire extinguisher mounted therein;

FIG. 6 is a longitudinal cross section view through the range hood as seen along line 6-6 in FIG. 5;

FIG. 7 is a transverse cross-section view through the range hood as seen along line 7-7 in FIG. 6.

### DETAILED DESCRIPTION OF ONE EMBODIMENT OF THE PRESENT INVENTION

While this invention is susceptible of embodiments in many different forms, there is shown in the drawings and will be described in details herein, one specific embodiment of a portable fire extinguisher. It should be understood that the present disclosure is to be considered as an example of the principles of the invention and is not intended to limit the invention to the embodiment illustrated and described.

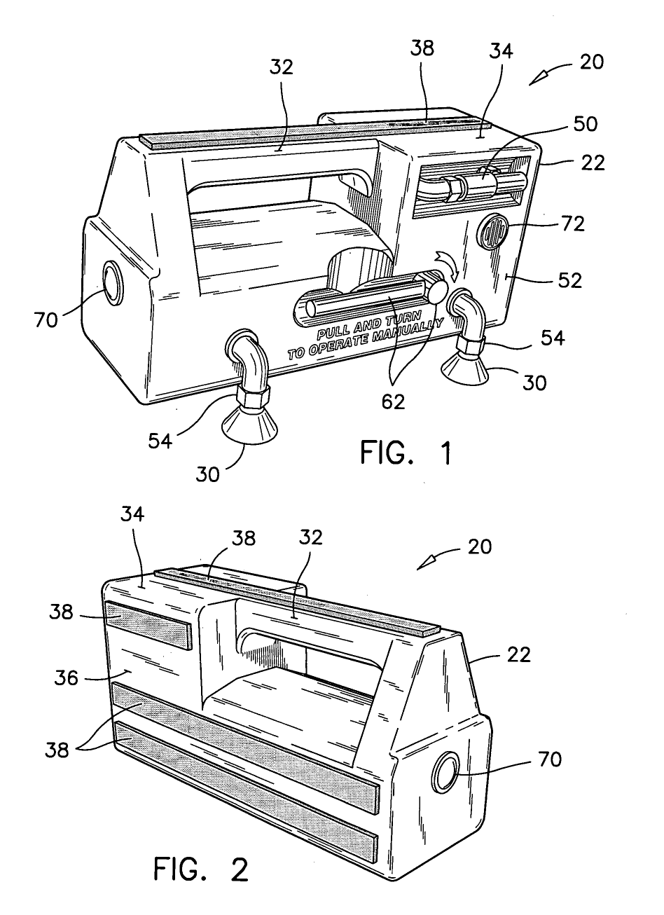

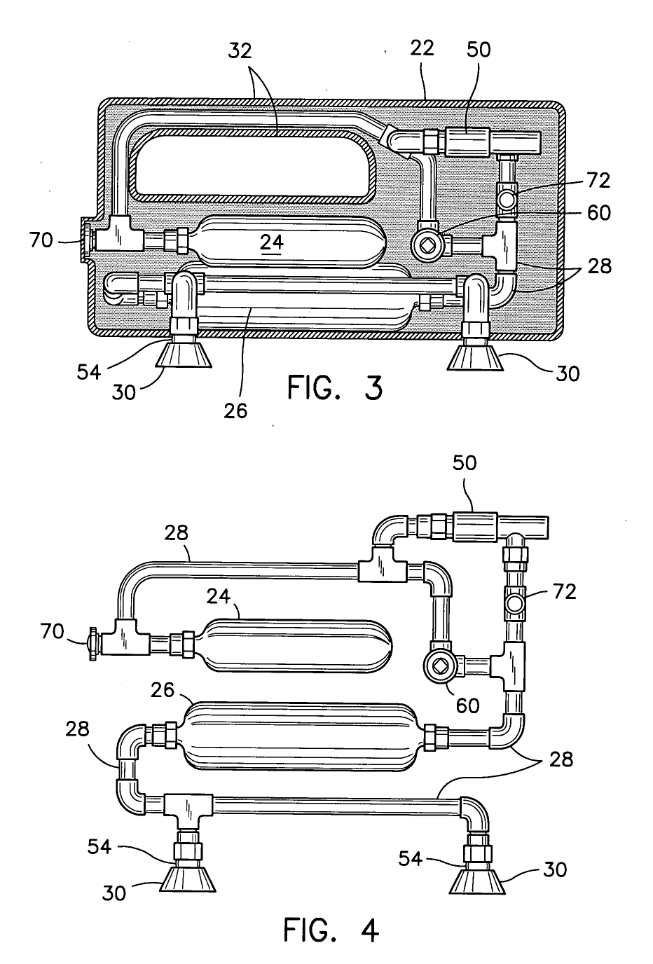

Referring firstly to FIGS. 1-4, the fire extinguisher 20 embodying the features of the present invention has a housing 22 enclosing a cylinder 24 of inert gas under pressure; a reservoir 26 of fire suppressant material, and a piping system 28 joining the gas cylinder 24 and the reservoir 26 to a pair of spray nozzles 30. The spray nozzles 30 are mounted outside the housing 22.

The housing 22 also has a carrying handle 32, an outside top surface 34 and an outside back surface 36. Both the top surface 34 and back surface 36 are substantially at right angle with each other and each surface has one or more magnets 38 affixed thereto for retaining the fire extinguisher 20 in a secured but detachable manner to the ceiling and side wall of a range hood made of ferrous metal.

When the fire extinguisher 20 is mounted inside a range hood that is made of stainless steel or copper for example, the magnets 38 are replaced by adhesive tape or mounting clips or brackets (not shown), such that the fire extinguisher 20 is detachable from the hood by hand without tool, in a similar manner as the pulling of the magnets 38 from a ferrous surface.

The fire extinguisher 20 also comprises a heat-responsive valve 50. The heat-responsive valve 50 is mounted outside the housing 22 and is connected to the piping system 28 in a serial manner between the cylinder 24 of gas under pressure and the reservoir 26 of fire suppressant material, such that the pressure from the gas cylinder 24 is retained by the valve 50 as long as the heat-responsive valve does not detect a specific ambient heat intensity.

When this specific ambient heat intensity is detected, in case of a fire on one of the burners on the kitchen range for example, the heat-responsive valve 50 opens, thereby letting the inert gas under pressure to flow into the reservoir 26 of fire suppressant material and forces the fire suppressant material through the nozzles 30.

The heat-responsive valve 50 illustrated in the drawings is of the type referred to as a thermally-activated pressure relief valve, or a fuse plug as may be referred to in the trade. Examples of these valves are provided in the U.S. Pat. No. 5,791,367 issued to D. J. Hackman et al., on Aug. 11, 1998. These pressure relief valves are commercially available. Other heat-responsive valves that are commercially available can also be used in the present invention to automatically detect abnormal heat and activate a delivery of fire suppressant material through the nozzles 30. The selection of a suitable heat-responsive valve 50 is a designer's choice.

The heat-responsive valve 50 is located outside the front surface 52 of the housing 22 near the top surface 34, and preferably as close as possible from the top surface 34 of the housing 22. The purpose of this preferred location for the heat-responsive valve 50 is to detect heat near the ceiling of a range hood in which the fire extinguisher 20 is mounted.

Both nozzles 30 protrude from the front surface 52 of the housing 22, and are oriented away from the carrying handle 32. The nozzles 30 are preferably connected to swivel joints 54 such that they can be oriented to deliver fire suppressant material toward any one of the burners on the kitchen range below the fire extinguisher 20.

One important element of the fire extinguisher 20 is that it has a manual valve 60 mounted along the piping system 28, in a parallel arrangement with the heat-responsive valve 50. This manual valve 60 has a valve stem or valve handle 62, extending outside the housing 22 such that the valve is operable by hand to bypass the heat-responsive valve 50 so that one can use the fire extinguisher 20 in a manual mode in a case of emergency.

As an optional equipment, the fire extinguisher 20 may have a pop-out test button 70 connected to the piping system 28 for verifying the pressure in the gas cylinder 24 and in the piping system 28. Another optional accessory is an audible alarm 72 also connected to the piping system downstream of the valve 50, for warning occupants of an apartment in the case of a discharge of the fire extinguisher 20 over the kitchen range of that apartment for example. The audible alarm 72 is not required when operating the fire extinguisher 20 in a manual mode, and therefore, it preferably contains a check valve (not shown) for preventing a flow of gas there through from the manual valve 60.

It will be appreciated by those knowledgeable in the field of fire prevention that the reservoir of fire suppressant material 26 is also optional when the inert gas under pressure in the cylinder 24 is carbon dioxide. This material has fire extinguishing properties of its own and can be delivered directly to the nozzles 30 to smother a cooking fire.

It will also be appreciated that the gas under pressure could be other inert gas such as argon for example, and in that case, a separate reservoir of fire extinguishing material 26 is required.

In both cases, the gas cylinder 24 is preferably filled to about 75% of its capacity. Although gas cylinders available commercially can resist high temperature and pressure, it is recommended that the gas cylinders 24 should be only partly filled such that its internal pressure will not exceed its rated pressure capacity at a temperature at which the heat-responsive valve 50 is set to operate. As an option or a complementary feature, the gas cylinder 24 is preferably insulated against rapid heat rise, to ensure a safe operation of the fire extinguisher 20.

The essential elements in this first aspect of the present invention comprises a detachable mounting 38 of the fire extinguisher 20 under a range hood, a source of fire extinguishing material 24 under pressure, at least one nozzle 30 to deliver the fire extinguishing material there through, and a pair of valves 50, 60 mounted in parallel with each other for selectively controlling in a manual mode or in an automatic mode, the delivery of fire extinguishing material to the nozzle 30.

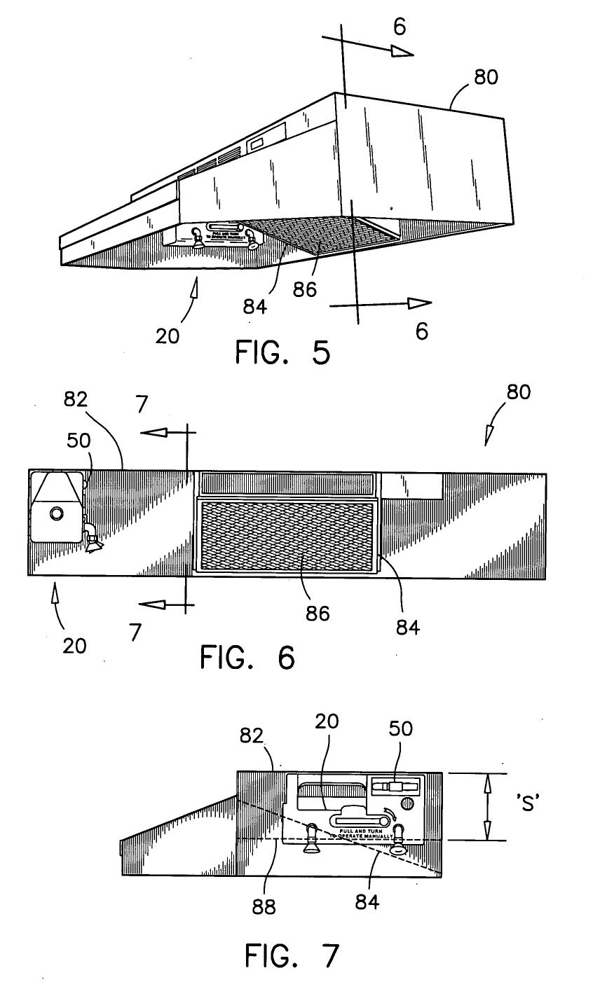

Referring now to FIGS. 5-7, another important aspect of the present invention will be explained. The fire extinguisher 20 has a heat-responsive valve 50 mounted near the upper surface 34 thereof such that when it is mounted under a range hood 80, the heat-responsive valve 50 is held near the ceiling 82 of the range hood 80 for detecting intensive heat in that region of the range hood.

Typical range hoods have a fan box 84 at the center thereof, to draw air from over the range surface and to circulate this air through a charcoal filter and back into the room, or to expel it outside the kitchen through a duct connected to the fan box. The charcoal filter 86 is normally mounted to the fan box to cover the intake opening of the fan box 86. Because of this common structure, there is a region of active air movement under the hood, near and below the intake opening of the fan box 84.

There is also a region of stagnant air above the opening of the fan box 84, wherein heat rises and is trapped. This region is referred to as a region of stagnant air and is illustrated by the dimension ‘S’ in FIG. 7, extending between the ceiling 82 of the range hood 80, and the inlet opening of the fan box 84.

Whether the inlet opening of the fan box 84 is inclined or horizontal, it is believed that stagnant air can be found in the upper portion of the range hood, above a mid-point along the inlet opening of the fan box 84, as illustrated by line 88 and dimension ‘S’.

In the occurrence of a cooking fire under the range hood 80, heat rises and accumulates in the region of stagnant air ‘S’. Because of the low air movement in that region, it is believed that the fastest heat rise is found in that region ‘S’. The placement of the heat-responsive valve 50 near the ceiling 82 of the range hood in the region of stagnant air is an ideal location for detecting a fire as quickly as possible.

Although an under-cabinet range hood has been illustrated and described hereinbefore, it will be appreciated that the fire extinguisher 20 can also be incorporated in a free-hanging range hood or in a microwave range hood combination for example, to detect high heat intensity in a stagnant air region of that hood. It is believed that the fire extinguisher can also be used to detect heat in a region of stagnant air in a lab-type exhaust hood. The fire extinguisher can further be incorporated in the engine compartment of a vehicle for example to detect high heat intensity near the inside surface of the hood of the vehicle and to promptly extinguish a engine fire. Therefore, the under-cabinet range hood 80 illustrated should not be considered as a limitation to the possible applications of the fire extinguisher 20.

In another aspect of the present fire extinguisher, the mounting magnets 38 are located on two perpendicular planes 34, 36 opposite the position and orientation of the nozzles 30. When the gas from the cylinder 24 is released all at once, a moment on the housing 22 is generated by the force of the spray of fire suppressant material through the nozzles 30. That moment causes a torque on the housing 22 which could cause the housing 22 to detach from the hood, if that housing would be retained by one side only, or from the top surface only. The magnetic strips 38 on both surfaces of the housing 22 can better resist that torque to prevent unexpected detachment of the fire extinguisher 20 from the hood 80.

Although a single embodiment of the present invention has been illustrated and described, the above description and the illustrations should not be construed as limiting the scope of the invention, which is defined by the appended claims.

What is claimed is:

1. A fire extinguisher comprising fire suppressant gas under pressure in a first container, a spray nozzle for delivering said fire suppressant gas in a direction of a fire, and a piping system connecting said first container to said nozzle; said piping system comprising a manual valve and a heat-responsive valve mounted in parallel with each other for selectively holding and releasing said gas to said nozzle in a manual or automatic mode.

2. The fire extinguisher as claimed in claim 1 wherein said housing comprises a carrying handle thereon for manual retention thereof when said manual valve is operated.

3. The fire extinguisher as claimed in claim 1, wherein said piping system further comprises a swivel joint connecting said nozzle thereto.

4. The fire extinguisher as claimed in claim 1, wherein said first container is partly filled to about 75% of its capacity with fire suppressant gas.

5. The fire extinguisher as claimed in claim 1, further comprises a reservoir of fire-suppressant material mounted in said piping system downstream from said first container and said valves.

6. The fire extinguisher as claimed in claim 5, further comprises a housing containing said first container, said reservoir of fire suppression material and a portion of said piping system.

7. The fire extinguisher as claimed in claim 6, wherein said housing has an upper surface, a carrying handle formed in said upper surface, and said nozzle being oriented away from said upper surface.

8. The fire extinguisher as claimed in claim 7, wherein said housing comprises first means for detachably retaining said upper surface to a ceiling of a range hood.

9. The fire extinguisher as claimed in claim 7, wherein said heat-responsive valve is located near said upper surface of said housing.

10. The fire extinguisher as claimed in claim 8, wherein said housing has a back surface relative to a position of said nozzle, and said back surface has second means for detachably retaining said housing to a range hood.

11. The fire extinguisher as claimed in claim 10, wherein said first and second means for detachably retaining comprise magnets.

12. A fire extinguisher having a housing, at least one nozzle protruding from said housing, and a heat-responsive valve extending outside said housing; said housing containing a cylinder of inert gas under pressure, a reservoir of fire suppressant material, and a piping system connecting said cylinder to said heat-responsive valve, said heat-responsive valve to said reservoir of fire suppressant material, and said reservoir of fire suppressant material to said nozzle; said housing having a carrying handle thereon and magnets on a surface thereof for retention thereof to a ferrous surface of a range hood in a detachable manner; said piping system also having a manual valve mounted in parallel with said heat-responsive valve for selective operation thereof in a manual mode.

13. The fire extinguisher as claimed in claim 12, wherein said housing has top and back surfaces at substantially a right angle with each other, and said magnets are affixed to said top and back surfaces.

14. The fire extinguisher as claimed in claim 13, wherein said housing has a front surface opposite said back surface and said heat-responsive valve is mounted along said front surface near said top surface.

15. The fire extinguisher as claimed in claim 14, wherein said carrying handle is formed in said top surface of said housing.

16. The fire extinguisher as claimed in claim 12, wherein said piping comprising a swivel joint connecting said nozzle thereto.

17. The fire extinguisher as claimed in claim 15, wherein said nozzle is oriented away from said carrying handle and said manual valve has a valve handle protruding from said front surface of said housing.

18. In combination, a range hood having a ceiling and a zone of stagnant air at a proximity of said ceiling, and a fire extinguisher mounted inside said range hood; said fire extinguisher comprising at least one nozzle; a heat-responsive valve; a reservoir of fire suppressant material, and means to expel a content of said reservoir through said nozzle, said heat-responsive valve having means for triggering said means to expel, and being mounted in said zone of stagnant air near said ceiling for detecting intense heat near said ceiling and for triggering said means to expel.

19. The combination as claimed in claim 18, wherein said fire extinguisher comprises a housing having top and back surfaces at substantially a right angle with each other and magnets affixed to said top and back surfaces for retaining said fire extinguisher to a surface of said range hood.

20. The combination as claimed in claim 19, wherein said fire extinguisher further has a handle formed on said housing and a manual valve mounted in parallel with said heat-responsive valve, for selective operation of said fire extinguisher in a manual mode.
